(19) United States
(12) Patent Application Publication
(10) Pub. No.: US 2026/0302628 A1
(43) Pub. Date: Oct. 1, 2026

(54) ONBOARD UNIT FOR A WIRELESS VEHICLE IDENTIFICATION SYSTEM

(71) Applicant: Kapsch TrafficCom AG, Wien (AT)

(72) Inventor: Stefan SCHIDL, Wien (AT)

(21) Appl. No.: 19/478,166

(22) PCT Filed: Mar. 27, 2024
(86) PCT No.: PCT/EP2024/058346

§ 371 Date: Oct. 23, 2025

(30) Foreign Application Priority Data
Apr. 26, 2023 (EP) 23170058.4

(51) Int. Cl. H01Q 9/04; H01Q 1/12; H01Q 1/32; H01Q 19/10

(52) U.S. Cl. CPC H01Q 9/0457; H01Q 1/1271; H01Q 1/3208; H01Q 19/10

(57) ABSTRACT

An onboard unit for wireless communication with a vehicle identification system via radio waves comprises a housing with a front side and a rear side and a circuit board therein, an antenna connected to the circuit board and arranged in the housing near the front side, and a solar cell supported by the housing near the rear side, powering the circuit board and having a photosensitive side and an electrically conductive layer, the photosensitive side being visible from outside the housing, and an attaching element for attaching the housing to a windscreen of a vehicle with the front side of the housing facing the windscreen.

### CROSS-REFERENCE TO RELATED APPLICATIONS

This application is a National Phase application of International Application No. PCT/EP2024/058346 filed Mar. 27, 2024 which claims priority to the European Patent Application No. 23 170 058.4 filed Apr. 26, 2023, the disclosures of which are incorporated herein by reference.

### TECHNICAL FIELD

The present disclosed subject matter relates to an onboard unit for wireless communication with a vehicle identification system, in particular a road toll, parking space management or access system, via radio waves.

### BACKGROUND

Onboard units (OBUs) of this type use a wide variety of short range communication standards for wireless communication such as DSRC (Dedicated Short Range Communication), in particular CEN-DSRC, ETSI ITS-G5, WAVE, WLAN (in particular IEEE 802.11x), RFID, NFC etc. Radio waves around 5.8 GHz or 5.9 GHz are commonly used, yielding wave lengths of about 5 cm.

The onboard units typically have a battery-powered transponder with an antenna for this sort of wireless communication. Recently, solar-powered onboard units have been proposed to extend the battery life or get rid of the battery at all, see, e.g., US 2006/0244573 A1, CN 203567522 U, CN 105469610 A, CN 209730882 U, CN 110751739 A or US 2012/0234922 A1.

### BRIEF SUMMARY

It is an object of the disclosed subject matter to improve solar-powered onboard units with respect to their wireless communication capabilities.

This object is achieved by means of an onboard unit for wireless communication with a vehicle identification system via radio waves, comprising:
a housing with a front side and a rear side and a circuit board in the housing,
an antenna for radio waves which is connected to the circuit board and arranged in the housing near the front side, and
a solar cell supported by the housing near the rear side, powering the circuit board and having a photosensitive side and an electrically conductive layer, the photosensitive side being visible from outside the housing,
the onboard unit being distinguished by an attaching element for attaching the housing to a windscreen of a vehicle with the front side of the housing facing the windscreen.

The onboard unit of the disclosed subject matter uses the solar cell not only to power the onboard unit but also to shield the antenna, at least partially, from unwanted signals emanating from the interior of the vehicle, for instance from mobile or smart phones, laptops or the like. To this end, the onboard unit can be mounted, by means of the attaching element, with the front side of the housing—and thus the antenna—facing the windscreen and the rear side of the housing—and thus the solar cell—facing the interior of the vehicle. Hence, the solar cell, in particular its electrically conductive layer, substantially attenuates unwanted signals before they reach the antenna to prohibit deterioration of the received signal and the onboard unit's communication capabilities by such signals.

The disclosed onboard unit has, thus, two distinctive sides, a front side with an antenna for improved radio communication and a rear side with a solar cell for powering and shielding. The front side can face the vehicle's identification system, e.g., radio beacons along or across the road, while the rear side can face the ambient light and the unwanted signals in the vehicle interior to energise the solar cell and shield the antenna. In effect, a solar-powered onboard unit with improved radio communication is provided.

In an optional embodiment, the attaching element is provided on the front side of the housing. In this way, the attaching element can be particularly compact and lightweight.

The attaching element may be any element suitable for attaching the housing to the windscreen while its front side faces the same. For attaching the housing quickly and easily to the windscreen, the attaching element advantageously comprises an adhesive strip or a suction cup.

To adjust the orientation of the housing (and hence of the antenna for radio communication and of the solar cell for powering and shielding) and/or the distance between the housing and the windscreen (and hence the influence of the windscreen on the antenna), it is beneficial when the attaching element comprises an adjustable mount for adjusting an angle and/or a distance between the windscreen and the housing attached thereto. Moreover, the adjustable mount allows to direct the radio antenna at a desired angle towards the vehicle's identification system also for differently oriented types of the windscreen, e.g., in passenger cars and trucks.

The antenna and the solar cell may be mutually arranged in many ways to shield the antenna from unwanted signals. In a favourable embodiment, seen in a direction from the front side to the rear side, the antenna and the solar cell are arranged substantially concentrically. Thereby, a particularly effective shielding of unwanted signals that impinge orthogonal onto the rear side can be achieved.

To further enhance the shielding effect, the solar cell, seen in a direction from the front side to the rear side, is optionally larger than the antenna.

According to an optional feature of the disclosed subject matter, the antenna is a patch antenna parallel to the electrically conductive layer. The distance between the antenna and the electrically conductive layer will then be constant and the shielding can be easily designed and obtained.

In an optional variant of this embodiment the patch antenna is an aperture-coupled patch antenna in form of a metallic layer on a substrate attached to the front side of the circuit board which has a slot going through from its front to its rear side, wherein a microstrip connector is used to couple a high frequency signal through the slot into the patch antenna for emission as radio waves. An aperture-coupled patch antenna can achieve a high antenna efficiency at a small size and thus an easy integration in the housing.

For an efficient shielding also with a small sized solar cell, it is beneficial when the solar cell has a length orthogonal to the slot in the range of a half to three halves of, e.g. the size of, the wavelength of the center frequency of the radio waves. Similarly, it is beneficial when the solar cell has a width parallel to the slot in the range of a half to three halves of, e.g. half the size of, the wavelength of the center frequency of the radio waves.

Advantageously, the antenna may be arranged at a distance from the electrically conductive layer of the solar cell such that radio waves penetrating the front side interfere at the antenna with radio waves reflected by the electrically conductive layer. Thereby, the electrically conductive layer of the solar cell also acts as a reflector for the radio waves of the antenna, to use it as additional steering radio power for communication. The electrically conductive layer of the solar cell redirects the radio waves towards the antenna, improving the antenna gain in a selected direction. For example, when the distance is chosen such that the radio waves penetrating the front side constructively interfere at the antenna with the radio waves reflected by the electrically conductive layer, the antenna gain in a direction normal to the extension of the antenna is increased. Alternatively, if the distance is chosen such that the radio waves penetrating the front side destructively interfere at the antenna with radio waves reflected by the electrically conductive layer, the antenna gain in side lobes off the normal direction is increased.

To achieve constructive interference by making radio waves penetrate the front side interfere at the antenna with radio waves reflected by the electrically conductive layer, the distance may be chosen such that

$$2 \cdot D = n \cdot λ \pm δ ,$$

with
D . . . being the distance,
n . . . being an integer,
λ . . . being the wavelength of the center frequency of the radio waves, and
δ . . . being in the range of 0≤δ<λ/3.

Optionally, the distance of the electrically conductive layer of the solar cell to the antenna is an integer multiple of half the wavelength of the center frequency of the radio waves, increasing constructive interference in a given frequency band.

The electrically conductive layer of the solar cell can be any type, e.g., a grid or mesh of wires across the photosensitive side of the cell (“front-contacted solar cell”) or, in case of a rear-contacted solar cell, a continuous sheet or coating of conductive material across its rear side. In case of a grid or mesh the holes of the grid or mesh should, of course, be significantly smaller than the wavelength of the radio waves.

In front-contacted solar cells the electrically conductive layer of the solar cell might even face away from the antenna. Alternatively, however, the electrically conductive layer faces the antenna to avoid attenuation of the reflected radio waves used for constructive interference.

### BRIEF DESCRIPTION OF THE DRAWINGS

The disclosed subject matter will now be described in further detail by means of an exemplary embodiment thereof under reference to the enclosed drawing, in which show:

FIG. 1 a first exemplary embodiment of an onboard unit of the disclosed subject matter attached to a windscreen in a side view;

FIG. 2 the onboard unit of FIG. 1 in a rear view;

FIG. 3 the onboard unit of FIGS. 1 and 2 in a sectional view according to the section II-II in FIG. 2;

FIG. 4 an exemplary patch antenna for the onboard unit of FIGS. 1 to 3 in an exploded perspective view; and

FIG. 5 a second exemplary embodiment of an onboard unit of the disclosed subject matter attached to a windscreen in a side view.

### DETAILED DESCRIPTION

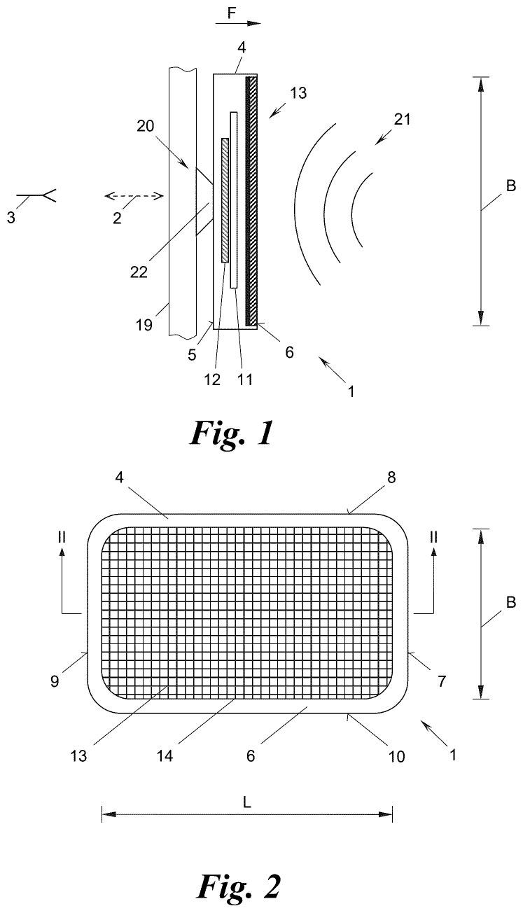

FIGS. 1 to 3 show a first embodiment of an onboard unit 1 for wireless communication 2 via radio waves W, W′ with a (symbolically depicted) vehicle identification system 3. The onboard unit 1 may be installed on any sort of vehicle, e.g., a car, truck, train, ship, aircraft etc. The vehicle identification system 3 can be any system which requires a vehicle to be identified, e.g., a road toll system (electronic toll collection system, ETCS), a parking space management system, an access system for restricted areas like cities, country borders etc., a management system for shunting yards, airport aprons, gates for ships, or the like.

The wireless communication 2 between the onboard unit 1 and the system 3 can be based on any short range communication standard, e.g., a DSRC standard according to CEN, UNI or ETSI ITS-G 5, a WAVE standard according to IEEE 802.11x, a WLAN, RFID, NFC or Bluetooth standard or the like. In the present example the onboard unit 1 is a DSRC OBU for an ETCS, and the wireless communication 2 operates in frequency bands around center frequencies of 5.8 GHz or 5.9 GHz, respectively, equivalent to a wavelength 2 of about 5 cm.

The onboard unit 1 has a housing 4 in the form of a small flat box with a front side 5, a rear side 6 and four lateral sides 7-10. The housing 4 can have any shape and size as long as it has two opposite sides of which one can serve as a front side 5 and another one can serve as a rear side 6.

The housing 4 protects and mounts a circuit board 11, e.g., a printed circuit board (PCB), with all the electronics that form an active or passive transponder for the wireless communication 2 with the system 3. An antenna 12 is electrically connected to the circuit board 11. The antenna 12 will in most cases be a patch antenna, i.e., an antenna extending in two dimensions. The antenna 12 may lie parallel to the front side 5 of the housing 4 to save space. For optimum communication, the antenna 12 can be nearly as large as the entire front side 5. The antenna 12 is near the front side 5 of the housing 4 and may be supported by the circuit board 11 and/or the housing 4.

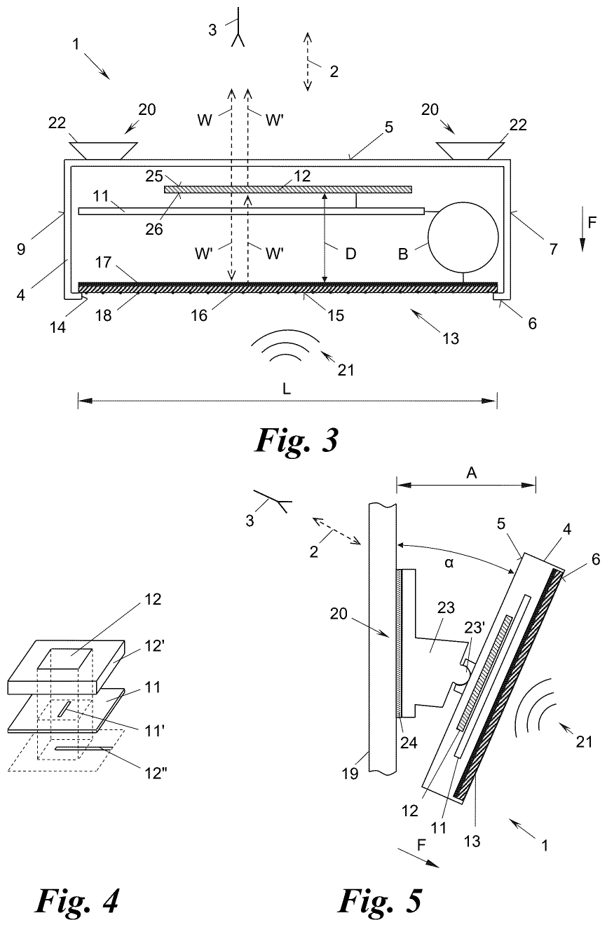

FIG. 4 shows an example of an aperture-coupled patch antenna 12 in form of a metallic layer on a substrate 12′ attached to the front (here: top) side of the circuit board 11. The circuit board 11 has a slot going through from its front to its rear (here: bottom) side, where a microstrip connector 12″ is used to couple a high frequency signal through the slot 11′ into the patch antenna 12 for emission as radio waves W, W′.

The circuit board 11 is powered by a solar cell 13 either directly or via a rechargeable battery B as an energy buffer. The solar cell 13 is supported by the housing 4 near the rear side 6 of the housing 4. The solar cell 13 can be applied onto the rear side 6 of the housing 4. Alternatively, the solar cell 13 can be installed in the housing 4 behind a window 14 in the rear side 6 that leaves at least the photosensitive side 15 of the solar cell 13 visible from outside the housing 4. The window 14 can be closed by a transparent cover or be left open.

The solar cell 13 can be of any known type, e.g., crystalline or amorphous, rigid or flexible. The solar cell 13 has a photovoltaic layer 16 converting light energy impinging on its photosensitive side 15 into electric energy. To this end the photovoltaic layer 16 is contacted by at least one electrically conductive layer 17. In some cases, the electrically conductive layer 17 will be a continuous sheet or coating of conductive material on the side of the solar cell 13 that faces away from its photosensitive side 15, while a grid or mesh of wires 18 at the photo-sensitive side 15 serves as an opposite electrode for the photovoltaic layer 16. The electrically conductive layer 17 may, however, itself be a grid or mesh of wires or conductors, for example in front-contacted solar cells. Generally speaking the solar cell 13 has at least one electrically conductive layer 17 co-extending with its photosensitive side 15 that is either a continuous conductive sheet or coating or at least a grid or mesh of electrical conductors with a spacing significantly smaller than the wavelength λ so that it acts very much like a continuous electrically conductive layer for that wavelength.

As can be seen in FIG. 1, the housing 4 of the onboard unit 1 is attached to a windscreen 19 of a vehicle by means of an attaching element 20. The attaching element 20 attaches the housing 4 in a manner that the front side 5 of the housing 4 faces the windscreen 19. Thus, the antenna 12 near the front side 5 faces the windscreen 19 and the vehicle identification system 3. On the other hand, the solar cell 13 faces the interior of the vehicle and shields the antenna 12 from unwanted electromagnetic signals 21 emanating from the vehicle's interior, e.g. emitted by electronic devices such as cell phones, smart phones, laptops, etc.

The attaching element 20 may be any element capable to attach the housing 4 to the windscreen 19 while its front side 5 faces the windscreen 19 and may be provided on the front side 5 or another side 6-10, e.g., projecting therefrom and reaching for the windscreen 19.

In the example of FIGS. 1 and 3, the attaching element 20 is formed by one or more (here: two) suction cups 22 which are provided on the front side 5 of the housing 4. In another example (not shown), the attaching element 20 may be formed by one or more adhesive strips provided on the front side 5 of the housing 4.

In the example of FIG. 5, the attaching element 20 is formed by an adjustable mount (here: a mounting foot) 23 with an adhesive strip 24 thereon for adhering to the windscreen 19. Alternatively, the mounting foot 23 may have other attaching means for attaching to the windscreen 19, e.g. one or more suction cups 22 etc.

The mounting foot 23 mounts the housing 4 in an adjustable, i.e. movable, manner. In one variant, the mounting foot 23 mounts the housing 4 pivotably, e.g., by means of a hinge 23′ (FIG. 5), a pivot, a ball joint or the like, to adjust an angle a between the windscreen 19 and the housing 4 and to orient the antenna 12 towards the identification system 3. In another variant the mounting foot 23 mounts the housing 4 linearly movably, e.g., by means of a slide or the like (not shown), to adjust a distance A between the windscreen 19 and the housing 4. The two variants may optionally be combined to adjust the angle a and the distance A.

While the mounting foot 23 of FIG. 5 mounts the front side 5 of the housing 4, in other embodiments the mounting foot 23 mounts another side 6-10 of the housing 4 to attach the housing 4 adjustably to the windscreen 19.

Instead of the adjustable mount 23 shown, the attaching element 20 may be formed by, e.g., a rigid mount with attaching means like described above with respect to the adjustable mount 23.

The antenna 12 and the solar cell 13 may have various mutual shapes, arrangements and proportions to shield the unwanted signals 21.

In the embodiments shown, the antenna 12 and the solar cell 13 are essentially rectangular; in other embodiments, they may have different shapes.

According to FIGS. 1, 3 and 5, the antenna 12 and the solar cell 13 may optionally be arranged substantially concentrically when seen in a direction F from the front side 5 to the rear side 6, i.e., when seen in that direction F, their respective centers are distanced by less than, e.g., 10% of the wavelength λ of the center frequency of the radio waves W, W′. Moreover, the solar cell 13 may be larger than the antenna 12 when seen in the direction F to improve the shielding of the antenna 12.

Optionally, a length L of the solar cell 13 orthogonal to the slot 11′ and a width B of the solar cell 13 parallel to the slot 11′ may each be smaller than three halves of the wavelength λ of the center frequency of the radio waves W, W′. Effective shielding is achieved in particular when the length L is in the range of a half to three halves of said wavelength λ and/or the width B is in the range of a half to three halves of said wavelength λ. For instance, the length L may be the size of said wavelength λ and the width B may be half the size of said wavelength λ.

As shown in FIG. 3, the antenna 12 is arranged at a distance D from the electrically conductive layer 17 of the solar cell 13. The distance D may be utilised, on the one hand, to tailor the shielding by the solar cell 13 and, on the other hand, to tailor the characteristics of the antenna 12. In the example of FIG. 3, the antenna 12 is parallel to the electrically conductive layer 17 so that the distance D is constant over the extension of the antenna 12, although different profiles of the distance D may be suited for different types of antennas 12. The antenna 12 and the electrically conductive layer 17 may thus not necessarily be planar as shown but could also be curved, e.g., in parallel.

In the example of FIG. 3, the distance D-which here also includes the averaged distance D of a distance profile-is chosen such that the electrically conductive layer 17 acts as a useful reflector for the antenna 12, which is optional. In particular, the antenna 12 emits/receives both (i) radio waves W from/to its front side 25 that faces the front side 5 of the housing 4 and (ii) radio waves W′ from/to its rear side 26 that faces the solar cell 13. The latter radio waves W′ are reflected by the electrically conductive layer 17 and redirected as reflections to the antenna 12. The reflected radio waves W′ interfere at the antenna 12 with the radio waves W in constructive interference when the distance D is about half the wavelength λ of the center frequency of the frequency bands of the radio waves W, W′, or any integer multiple thereof. More specifically, for constructive interference the distance D is chosen such that

$$2 \cdot D = n \cdot λ ( n = 1 , 2 , 3 , … ) \pm δ ,$$

with δ in the range of 0≤δ<λ/3.

Alternatively, the reflected radio waves W′ interfere at the antenna 12 with the radio waves W in destructive interference when the distance D is outside of the above ranges.

The disclosed subject matter is not restricted to the specific embodiments described in detail herein but encompasses all variants, modifications and combinations thereof which fall into the scope of the appended claims.

1. An onboard unit for wireless communication with a vehicle identification system via radio waves comprising:
a housing with a front side and a rear side,
a circuit board in the housing,
an antenna for radio waves which is connected to the circuit board and arranged in the housing near the front side,
a solar cell supported by the housing near the rear side, powering the circuit board and having a photosensitive side and an electrically conductive layer, the photosensitive side being visible from outside the housing, and
an attaching element for attaching the housing to a windscreen of a vehicle with the front side of the housing facing the windscreen, such that, in an attached position, the front side faces the windscreen and the solar cell faces the interior of the vehicle.

2. The onboard unit according to claim 1, wherein the attaching element is provided on the front side of the housing.

3. The onboard unit according to claim 1, wherein the attaching element, for attaching the housing to the windscreen, comprises an adhesive strip or a suction cup.

4. The onboard unit according to claim 1, to wherein the attaching element comprises an adjustable mount for adjusting an angle, a distance, or both the angle and the distance between the windscreen and the housing attached thereto.

5. The onboard unit according to claim 1, wherein, seen in a direction from the front side to the rear side, the antenna and the solar cell are arranged substantially concentrically.

6. The onboard unit according to claim 1, wherein, seen in a direction from the front side to the rear side, the solar cell is larger than the antenna.

7. The onboard unit according to claim 1, wherein the antenna is a patch antenna which is parallel to the electrically conductive layer.

8. The onboard unit according to claim 7, wherein the patch antenna is an aperture-coupled patch antenna in form of a metallic layer on a substrate attached to a front side of the circuit board which has a slot going through from the front to a rear side of the circuit board, wherein a microstrip connector is used to couple a high frequency signal through the slot into the patch antenna for emission as radio waves

9. The onboard unit according to claim 8, wherein the solar cell has a length orthogonal to the slot in a range of a half to three halves of a wavelength of a center frequency of the radio waves.

10. The onboard unit according to claim 8, wherein the solar cell has a width parallel to the slot in a range of a half to three halves of a wavelength of a center frequency of the radio waves.

11. The onboard unit according to claim 1, wherein the antenna is arranged at a distance from the electrically conductive layer of the solar cell such that radio waves penetrating the front side interfere at the antenna with radio waves reflected by the electrically conductive layer.

12. The onboard unit according to claim 11, wherein the distance is chosen such that
$$2 \cdot D = n \cdot λ \pm δ ,$$
with
D . . . being the distance,
n . . . being an integer,
λ . . . being a wavelength of a center frequency of the radio waves, and
δ . . . being in a range of 0≤δ<λ/3.

13. The onboard unit according to claim 12, wherein the distance is an integer multiple of half the wavelength of the center frequency of the radio waves.

14. The onboard unit according to claim 1, to wherein the electrically conductive layer of the solar cell faces the antenna.

15. The onboard unit according to claim 8, wherein the solar cell has a length orthogonal to the slot of a size of a wavelength of a center frequency of the radio waves.

16. The onboard unit according to claim 8, wherein the solar cell has a width parallel to the slot of half a size of a wavelength of a center frequency of the radio waves.
